(19) United States
(12) Patent Application Publication
(10) Pub. No.: US 2019/0358709 A1
(43) Pub. Date: Nov. 28, 2019

(54) SMART CUTTING TOOL SYSTEM FOR USE IN PRECISION CUTTING

(71) Applicant: GUANGDONG UNIVERSITY OF TECHNOLOGY, Guangzhou, Guangdong (CN)

(72) Inventor: Xun Chen, Guangzhou, Guangdong (CN)

(21) Appl. No.: 16/304,151

(22) PCT Filed: Feb. 6, 2018
(86) PCT No.: PCT/CN2018/075498

§ 371 Date: Nov. 22, 2018

(30) Foreign Application Priority Data
Feb. 6, 2017 (CN) 201710065838.2

(51) Int. Cl. B23B 25/06; B23B 27/00

(52) U.S. Cl. CPC B23B 25/06; B23Q 15/007; B23B 27/00

(57) ABSTRACT

A smart cutting tool system for use in precision cutting, comprising a cutting insert (1), an upper cutter arbor (2), a lower cutter arbor (3), a first pressure sensor (4), a second pressure sensor (5), a signal processing module (6), a Bluetooth® transmission module (7), and a power supply (8), wherein the cutting insert (1) is fixed to a front end of the upper cutter arbor (2), the cutting insert (1) is provided at its rear end with a microgroove, in which the first pressure sensor (4) and the second pressure sensor (5) are inserted. The cutting tool system solves the problem of mutual coupling of various cutting forces, and has higher sensitivity.

### FIELD OF THE INVENTION

The present invention relates to the field of cutting tools, more particularly to a smart cutting tool system for use in precision cutting.

### BACKGROUND OF THE INVENTION

During machining process, an acquisition of information such as cutting force and cutting temperature is of great significance for optimizing processing parameters of the machining process and improving machining quality. In order to improve surface quality of parts machined by ultra-precision cutting and to efficiently and reliably produce large-sized parts with high surface figure accuracy, real-time state information of the cutting tool during machining process is crucial.

Now, during monitoring and researching of the machining process, the solution which involves integrated force sensor is usually adopted. However, the equipment is too complicated and huge and is difficult to install, which also affect the characteristics of the machine tool and adversely affect the rigidity and machining precision of the machine tool. Also, the solution which integrates the sensor with the cutter and is compact and highly integrated may be adopted. However, due to the cutting heat in the machining process, information distortion and invalidation may occur.

On the other hand, the existing systems for monitoring the cutting machining process usually use wire data or energy transmission, or use wireless detection schemes such as RFID, infrared and WIFI, or use wireless passive detection schemes based on surface acoustic wave. But these schemes have disadvantages as follows. The wire data or energy transmission has a limited range of use, because it can be applied only to the machining processes in which cutters remain stationary, but is not available for the machining processes in which cutters move synchronously. In RFID wireless data transmission schemes, the equipment can be powered by lithium batteries on account of its low power consumption. However, on one hand, the transmission distance which is usually less than 5 meters is too short, and on the other hand, the peak rate is approximately 200 kbps and real-time monitoring capability is affected due to the small amount of transferred data per unit time. The infrared wireless transmission schemes have lots of requirements in terms of communication distance, directivity and the like. For example, existing infrared technology not only is limited to a distance of 3 meters, but also has an acceptance angle seriously limited to 30°. It cannot be applied to point-to-multi-point transmission and thus has limited applications. Furthermore, high-speed and long-distance transmission can be implemented by means of WIFI, which not only meet the requirement of data transmission rate for ultra-precision machining and monitoring but also guarantee the real-time capability. However, WIFI transmission has not only poor data security, but also high power consumption and short battery life and thus cannot be applied to continuous machining process over long periods. Moreover, the wireless passive detection schemes based on surface acoustic wave use complex equipment and have short transmission distance as low as 0.5 meter. All schemes disclosed above meet neither the requirements of continuous high-reliable remote real-time wireless monitoring for ultra-precision machining process over long periods, nor the requirements of measurement precision and sensitivity for ultra-precision machining applications.

### SUMMARY OF THE INVENTION

Aiming at above shortcomings and application requirements of existing technologies, with the purpose of realizing high speed and high precision real-time monitoring and transmission of weak physical information during ultra-precision cutting process, the present invention provides a smart cutting tool system for use in precision machining based on high speed Bluetooth® transmission, which solve various problems of conventional smart cutting tool systems and has advantages such as high integration, very low power consumption, long continuous working time, high speed transmission, strong real-time capability, more parameters detection, high monitoring precision, low cost and ease of use.

The objectives of the present invention are achieved by the following technical solutions.

A smart cutting tool system for use in precision cutting comprises a cutting insert, an upper cutter arbor, a lower cutter arbor, a first pressure sensor, a second pressure sensor, a signal processing module, a Bluetooth® transmission module, and a power supply, wherein the signal processing module, the Bluetooth® transmission module, and the power supply are connected in this order by a wire and fixed to a rear end of the lower cutter arbor, and the power supply supplies power for all devices.

Herein, the cutting insert is fixed to a front end of the upper cutter arbor by means of a threaded fastener, and a tool tip of the cutting insert lies on a center line of a cross section of a main body of the upper cutter arbor.

The cutting insert is provided at its rear end with a microgroove, in which the first pressure sensor is inserted vertically. The threaded bolt is preloaded outside the microgroove in such a manner that the first pressure sensor and the upper cutter arbor can be sufficiently contacted with each other. The microgroove is positioned on the left side of the upper cutter arbor. When the cutting insert is subjected to a radial force in a horizontal direction, the first pressure sensor is in compression in a stress state, to measure the radial force in the horizontal direction.

The second pressure sensor is horizontally inserted in a gap between the connected upper cutter arbor and lower cutter arbor, and is fixed by a compressive stress of the upper cutter arbor and the lower cutter arbor which are fastened and connected, so as to measure a main cutting force in the vertical direction.

The first pressure sensor and the second pressure sensor are respectively electrically connected with the signal processing module. The first pressure sensor and the second pressure sensor can be used for collecting and processing signals. By means of the Bluetooth® transmission module, real-time state sensing signals of two direction cutting forces of the cutting tool can be transmitted to the machine tool numerical control system.

Further, the upper cutter arbor and the lower cutter arbor may be fastened and connected by four threaded fasteners.

Further, the lower cutter arbor may be arranged at its center line with a wire slot for wires, the wire slot leads to the rear of the cutter arbor, the upper cutter arbor and the lower cutter arbor may be fastened and connected, and the wire slot may be closed by the lower surface of the upper cutter arbor.

Further, the cutting insert may be a polycrystalline diamond insert.

Further, the upper cutter arbor and the lower cutter arbor may be made of 40Cr material.

Further, the first pressure sensor and the second pressure sensor may be PZT-5H type piezoelectric sensors.

Compared with the existing technologies, the present invention has advantages as follows.

(1) The present invention provides innovative arrangement for the positions of the pressure sensor in vertical direction and horizontal direction, realizes direct measurement of two direction cutting forces, solves the problem of mutual coupling of various cutting forces, achieves adjustable minimum threshold and dynamic stiffness for measurement by varying relevant parameters of the cutting tool, and has simple signal processing algorithm and higher sensitivity.

(2) The present invention provides the small-area microgroove on the cutter arbor and a pressure sensor inserted therein. Compared with the solutions that provide parts separated at first and then connected together, the present invention has less impact on the characteristics of the cutting tool and improved integral stiffness of the cutting tool.

(3) The present invention has very low energy consumption and is capable of realizing wireless monitoring of cutting process over long periods with the use of energy storing device, thus wired power supply normally is not necessary.

(4) The present invention is based on modular design, and it has high integration and low manufacturing cost and maintenance cost. It has less impact on the characteristics of the machine tool, and would not adversely affect the rigidity and machining precision of the machine tool.

(5) According to the present invention, obstacles or the machine tool have small impact on the signal detection, so that the reliability of wireless monitoring for ultra-precision cutting process is increased. The present invention has improved data transmission protocol adaptability, and is capable of realizing real-time monitoring by various terminals such as industrial control computers and mobile phones.

(6) The present invention has higher transmission rate and improved real-time monitoring capability, and the signal response time reaches to 0.2 ms.

(7) The present invention has high cutting force resolution which is up to 0.1N, and is significantly better than conventional RF and infrared smart cutting tool systems. Its precision is as good as conventional wired Kistler dynamometer.

(8) The present invention has long wireless transmission distance, and is capable of realizing wireless transmission of detected signals of the machining process at a distance of more than 10 m.

### BRIEF DESCRIPTION OF THE DRAWINGS

In order to describe embodiments of the invention or existing technical solutions more clearly, the drawings for the embodiments or existing technical solutions are briefly illustrated below. It is apparent that those described are merely some embodiments of the invention, and others can be derived by those skilled in the art without an inventive step.

FIG. 1 is a front view of a smart cutting tool system for use in precision cutting according to the invention;

FIG. 2 is a lateral view of a smart cutting tool system for use in precision cutting according to the invention;

In the drawings, 1. cutting insert; 2. upper cutter arbor; 3. lower cutter arbor; 4. first pressure sensor; 5. second pressure sensor; 6. signal processing module; 7. Bluetooth® transmission module; 8. power supply; 9. wire; 10. wire slot; 11. threaded fastener.

### DETAILED DESCRIPTION OF ILLUSTRATED EMBODIMENTS

In order to further clarify the purpose, solutions, and advantages of embodiments of the present invention, the embodiments of the present invention will be clearly described below in detail in conjunction with drawings of embodiments. It is clear that the described embodiments are only a part of embodiments of the present invention, not all embodiments of the present invention.

It should be understood that, as used herein, terms such as “upper” and “lower” for indicating orientation or position relationships are described referring to the orientation or position relationships in the drawings for convenience of description of the present invention, but are not intended to mean or hint that the described device or element must be arranged at a specific position or operated by a specific method at a specific position to limit the invention in any way. Furthermore, terms such as “first”, “second” and “third” are merely illustrative, but are not intended to mean or suggest relative importance, nor hint the numbers of the parts.

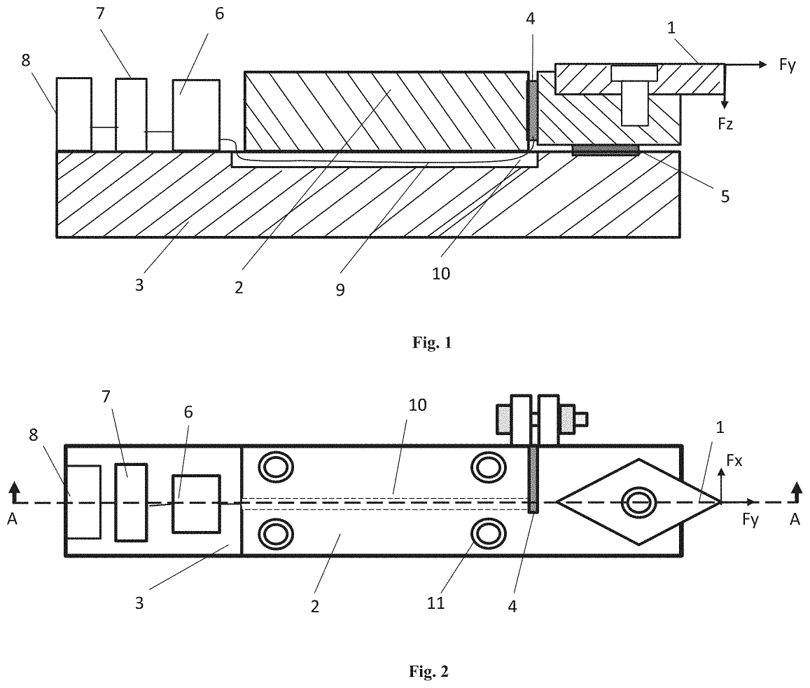

FIG. 1 is a front view of a smart cutting tool system for use in precision cutting according to the present invention; FIG. 2 is a lateral view of a smart cutting tool system for use in precision cutting according to the present invention. Referring to FIGS. 1-2, a smart cutting tool system for use in precision cutting according to the present invention comprises a cutting insert 1, an upper cutter arbor 2, a lower cutter arbor 3, a first pressure sensor 4, a second pressure sensor 5, a signal processing module 6, a Bluetooth® transmission module 7, and a power supply 8, wherein the signal processing module 5, the Bluetooth® transmission module 6, and the power supply 7 are connected in this order by wires and fixed to a rear end of the lower cutter arbor 3, and the power supply 8 supplies power for all devices.

Herein, the cutting insert 1 is fixed to a front end of the upper cutter arbor 2 by means of a threaded fastener, and a tool tip of the cutting insert 1 lies on a center line of a cross section of a main body of the upper cutter arbor 2.

The cutting insert 1 is provided at its rear end with a microgroove, in which the first pressure sensor 4 is inserted vertically. The threaded bolt is preloaded outside the microgroove, in such a manner that the first pressure sensor 4 and the upper cutter arbor 2 can be sufficiently contacted with each other. The microgroove is positioned on the left side of the upper cutter arbor 2. When the cutting insert 1 is subjected to a radial force in a horizontal direction, the first pressure sensor is in compression in a stress state to measure the radial force in the horizontal direction.

The second pressure sensor 5 is horizontally inserted in a gap between the upper cutter arbor 2 and the lower cutter arbor 3 which are connected, and is fixed by a compressive stress of the upper cutter arbor 2 and the lower cutter arbor 3 which are fastened and connected, so as to measure a main cutting force in the vertical direction.

The first pressure sensor 4 and the second pressure sensor 5 are respectively electrically connected with the signal processing module 6. The first pressure sensor 4 and the second pressure sensor 5 are used for collecting and processing signals. By means of the Bluetooth® transmission module 7, real-time state sensing signals of two direction cutting forces of the cutting tool can be transmitted to the machine tool numerical control system.

The upper cutter arbor 2 and the lower cutter arbor 3 are fastened and connected by four threaded fasteners 11.

The lower cutter arbor 3 is arranged at its center line with a wire slot 10 for wires, the wire slot 10 leads to the rear of the cutter arbor, the upper cutter arbor 2 and the lower cutter arbor 3 are fastened and connected, and the wire slot 10 is closed by the lower surface of the upper cutter arbor 2.

The cutting insert 1 is a polycrystalline diamond insert.

The upper cutter arbor and the lower cutter arbor are made of 40Cr materials.

The first pressure sensor and the second pressure sensor are PZT-5H type piezoelectric sensors. The pressure sensors of the invention may also be capacitive sensors or resistance sensors.

In another embodiment of the invention, a piezoelectric film is used instead of pressure sensors. In such case, main force goes to the tool tip of the cutting insert. By means of an algorithm, the radial force in the horizontal direction can be measured and calculated from the measured voltage measured by the piezoelectric film. The main cutting force in the vertical direction can be measured from the measured voltage measured by the piezoelectric film in another direction. The piezoelectric film is pre-stressed by a screw. The collected signals are transmitted to the signal processing module by the wire disposed within the cutting tool, and then transmitted to the acquisition end by means of the Bluetooth® transmission module. The signal processing module is disposed on the tool shank, signal transmission function is integrated to the cutting tool, such that smart cutting tool is realized.

The signal processing module and Bluetooth® transmission module used in the invention are common devices in the art, and those skilled in the art could select applicable signal processing modules and Bluetooth® transmission modules as needed.

The physical structure of the invention is simulated by FEA, optimized and tested in terms of stiffness and natural frequency, to ensure that the precision requirement for lathe machining can be met even when the lathe rotates at a speed of 6000-8000 rpm or more.

The present invention is intended to cover all embodiments, even derived from the embodiments disclosed herein without an inventive step. Although the present invention has been illustrated and described with reference to preferred embodiments, the intention is not to limit the present invention. Those skilled in the art may change or modify the embodiments without departing from the scope of the present invention.

1. A smart cutting tool system for use in precision cutting, characterized in that: it comprises a cutting insert, an upper cutter arbor, a lower cutter arbor, a first pressure sensor, a second pressure sensor, a signal processing module, a Bluetooth® transmission module, and a power supply, wherein the signal processing module, the Bluetooth® transmission module, and the power supply are sequentially connected by a wire and fixed to a rear end of the lower cutter arbor, and the power supply supplies power for all devices;
wherein the cutting insert is fixed to a front end of the upper cutter arbor by means of a threaded fastener, and a tool tip of the cutting insert lies on a center line of a cross section of a main body of the upper cutter arbor;
the cutting insert is provided at its rear end with a microgroove, in which the first pressure sensor is inserted vertically, the threaded bolt is preloaded outside the microgroove in such a manner that the first pressure sensor and the upper cutter arbor can be sufficiently contacted with each other, the microgroove is positioned on a left side of the upper cutter arbor, and when the cutting insert is subjected to a radial force in a horizontal direction, the first pressure sensor is in compression in a stress state to measure the radial force in the horizontal direction;
the second pressure sensor is horizontally inserted in a connection gap between the upper cutter arbor and lower cutter arbor, and is fixed by a compressive stress of the upper cutter arbor and the lower cutter arbor which are fastened and connected, so as to measure a main cutting force in the vertical direction; and
the first pressure sensor and the second pressure sensor are respectively electrically connected with the signal processing module, the first pressure sensor and the second pressure sensor are used for collecting and processing signals, and real-time state sensing signals of two direction cutting forces of the cutting tool can be transmitted to a machine tool numerical control system by means of the Bluetooth® transmission module.

2. The smart cutting tool system for use in precision cutting according to claim 1, characterized in that: the upper cutter arbor and the lower cutter arbor are fastened and connected by four threaded fasteners.

3. The smart cutting tool system for use in precision cutting according to claim 1, characterized in that: the lower cutter arbor is arranged at its center line with a wire slot for a wire, the wire slot leads to a rear of the cutter arbor, the upper cutter arbor and the lower cutter arbor are fastened and connected, and the wire slot is closed by a lower surface of the upper cutter arbor.

4. The smart cutting tool system for use in precision cutting according to claim 1, characterized in that: the cutting insert is a polycrystalline diamond insert.

5. The smart cutting tool system for use in precision cutting according to claim 1, characterized in that: the upper cutter arbor and the lower cutter arbor are made of 40Cr material.

6. The smart cutting tool system for use in precision cutting according to claim 1, characterized in that: the first pressure sensor and the second pressure sensor are PZT-5H type piezoelectric sensors.

7. The smart cutting tool system for use in precision cutting according to claim 2, characterized in that: the cutting insert is a polycrystalline diamond insert.

8. The smart cutting tool system for use in precision cutting according to claim 3, characterized in that: the cutting insert is a polycrystalline diamond insert.

9. The smart cutting tool system for use in precision cutting according to claim 2, characterized in that: the upper cutter arbor and the lower cutter arbor are made of 40Cr material.

10. The smart cutting tool system for use in precision cutting according to claim 3, characterized in that: the upper cutter arbor and the lower cutter arbor are made of 40Cr material.

11. The smart cutting tool system for use in precision cutting according to claim 2, characterized in that: the first pressure sensor and the second pressure sensor are PZT-5H type piezoelectric sensors.

12. The smart cutting tool system for use in precision cutting according to claim 3, characterized in that: the first pressure sensor and the second pressure sensor are PZT-5H type piezoelectric sensors.
